(19) United States
(12) Patent Application Publication
(10) Pub. No.: US 2006/0176257 A1
(43) Pub. Date: Aug. 10, 2006

(54) Color cholesteric liquid crystal display device and manufacturing method for the same

(76) Inventors: Hsing-Lung Wang, Ping Jen City (TW); Yi-An Sha, Taipei City (TW); Chi-Chang Liao, Tai Nan City (TW); Chih-Chiang Lu, Hsin Chu City (TW); Jau-Min Ding, Taipei City (TW)

Correspondence Address: RABIN & BERDO, P.C., Suite 500, 1101 14 Street, N.W., Washington, DC, 20005, US

(21) Appl. No.: 11/180,783

(22) Filed: Jul. 14, 2005

(30) Foreign Application Priority Data
Feb. 4, 2005 (TW) 94103642

(51) Int. Cl. G09G 3/36; G02F 1/1335; G09G 3/10

(52) U.S. Cl. 345/88; 349/88; 349/96; 315/169.3; 428/1.1

(57) ABSTRACT

A color cholesteric liquid crystal display device and a manufacturing method for the same are proposed in the present invention. A display device is made via an inkjet process and two ultraviolet exposure processes. The simple inkjet process is used, and an ultraviolet exposure is performed twice to provide a color cholesteric liquid crystal display device having a bistable feature. The display of the present invention is a flexible color cholesteric liquid crystal display device.

### BACKGROUND OF THE INVENTION

1. Field of the Invention

The present invention is related to a color cholesteric liquid crystal display device and a manufacturing method for the same, and more particularly to a color cholesteric liquid crystal display device with a bistable feature. The display is made of cholesteric liquid crystal material via an inkjet process and ultraviolet exposures (twice). In addition, the display is flexible.

2. Description of Related Art

In recent years, flexible displays, electronic papers and electronic books have been developed vigorously. The display media include liquid crystal displays, electronphoretic displays, electrochromic displays and electrolytic displays. In the application of electronic papers, compared with displays made of other display materials, the display made of a cholesteric liquid crystal material is brighter and has better contrast. In addition, the cholesteric liquid crystal display can be driven passively and produced easily.

Conventionally, for manufacturing color cholesteric liquid crystal display devices, two methods are often used. The first one uses a cholesteric structure with three layers. By stacking three cholesteric liquid crystal layers that can reflect different colors and using various driving methods, the display can reflect various colors. Its drawback is that the alignment of the panel with the three-layer structure cannot be achieved easily and this kind of display can only be bent slightly. The second one uses a cholesteric structure with a single layer, only. It mixes a twist agent that can be discomposed by light and a cholesteric liquid crystal material first. Then, ultraviolet light with different intensities is used to destroy or reduce the twist agent located at a single area. Thus, a single-layer display capable of reflecting various colors can be provided. However, this device with the single-layer structure is unreliable, and easily affected by the environment. Hence, this device needs to use an additional ultraviolet-proof layer for protection.

In the prior art, such as U.S. Pat. No. 5,949,513, “Methods of manufacturing multi-color liquid crystal displays using in situ mixing techniques,” a method for manufacturing multi-color liquid crystal displays via in situ mixing techniques is disclosed. Reference is made to FIG. 1, which is a schematic diagram of a structure of a conventional multi-color liquid crystal display manufactured via in situ mixing techniques. The structure includes a first substrate 10, a second substrate 12, a first twist agent 14, a second twist agent 16, integral spacing elements 18 and a display driver circuitry 20.

The technique disclosed in the above patent first places the first twist agent 14 and the second twist agent 16 at predetermined locations by printing. Then, a cholesteric liquid crystal material is infused. This patent focuses on using a color cholesteric liquid crystal material and a printing technique to manufacturing the multi-color liquid crystal display.

Furthermore, U.S. Pat. No. 6,331,884, “Method of making a liquid crystal display,” discloses a method that uses a liquid crystal material to make a liquid crystal device. Reference is made to FIG. 2, which is a schematic diagram for showing the manufacturing process of the conventional liquid crystal device. The liquid crystal device has multiple liquid crystal materials 30, multiple precursors 32, a first base 34, a second base 36, multiple conductive films 38, multiple insulating films 40, multiple bank structures 42 and an absorbing layer 44.

However, the above method for making the liquid crystal display disclosed in U.S. Pat. No. 6,331,884 has a drawback. In the above method, a resin material must be smeared on multiple insulating films 40 first. Then, multiple liquid crystal materials 30 are arranged by a printing process and a second base is placed thereafter. Lastly, an exposure process is provided to form multiple precursors 32. In this way, the thickness and manufacturing process of the display device is difficult to control. A higher driving voltage is required and the display device has poor image effects.

### SUMMARY OF THE INVENTION

An objective of the present invention is to provide a display device made via an inkjet process and two ultraviolet exposure processes. The present invention uses the simple inkjet process to provide a color cholesteric liquid crystal display device having a bistable feature. The display of the present invention is a flexible color cholesteric liquid crystal display device.

For reaching the objective above, the present invention provides a method for manufacturing a color cholesteric liquid crystal display device. It includes: printing multiple twist agents onto a first electrode layer of a lower base; coating a solution layer on the first electrode layer, where the solution layer is a mixture of a cholesteric liquid crystal material and monomers; forming multiple bank structures and multiple upper covers within the solution layer via ultraviolet exposure processes; and combining a second electrode layer with the lower base. The present invention provides a color cholesteric liquid crystal display device. It includes a lower base having a first electrode layer; multiple bank structures distributed over the lower base; multiple cholesteric liquid crystal materials provided among the bank structures; multiple upper covers provided on the cholesteric liquid crystal materials; and a second electrode layer provided on the upper covers.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram of a structure of a conventional multi-color liquid crystal display that is manufactured via in situ mixing techniques;

FIG. 2 is a schematic diagram for showing the manufacturing process of the conventional liquid crystal device;

FIGS. 3A-E show a schematic diagram of a color cholesteric liquid crystal display device in accordance with the first embodiment of the present invention; and

FIGS. 4A-E show schematic diagrams of a color cholesteric liquid crystal display device in accordance with the second embodiment of the present invention.

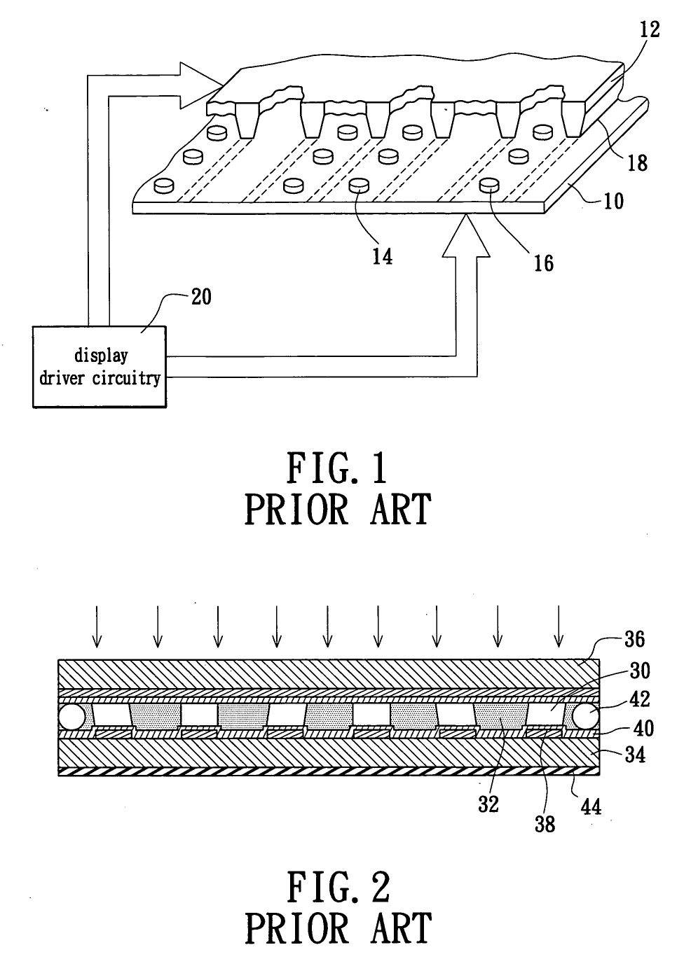

### DETAILED DESCRIPTION OF PREFERRED EMBODIMENTS

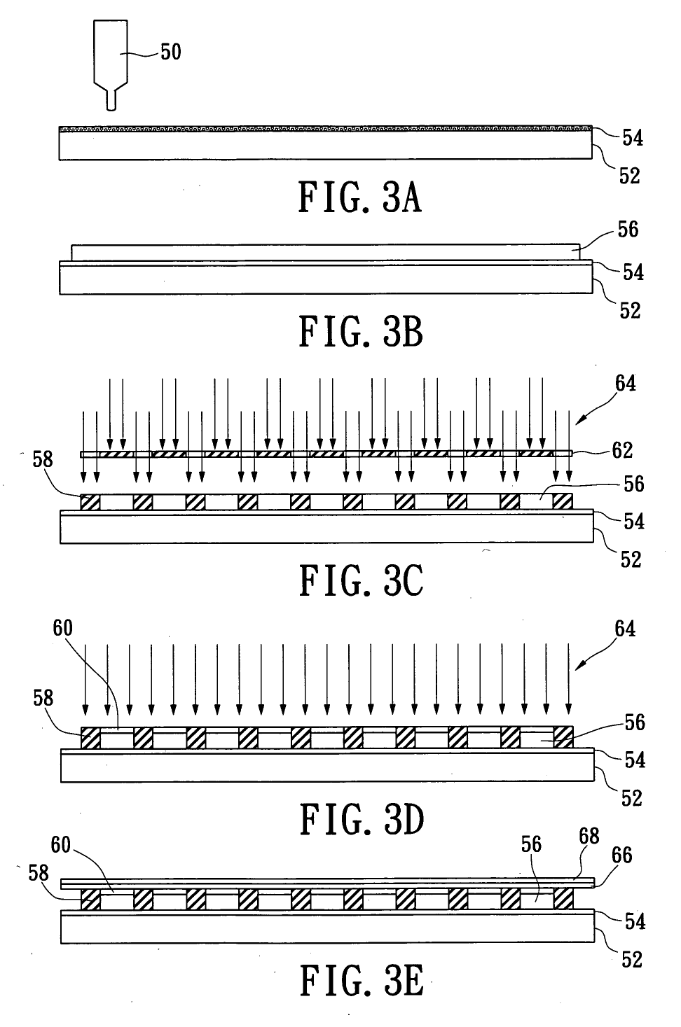

Reference is made to FIGS. 3A-E, which show a schematic diagram of a color cholesteric liquid crystal display device manufactured via an inkjet printing process in accordance with the first embodiment of the present invention. In FIG. 3A, different display areas are defined in a first electrode layer 54 of a lower base 52 and multiple twist agents are sprinkled on these areas. These twist agents can has different ingredient proportions or be reactive liquid crystal materials. The above lower base can be a glass base or a plastic base. The first electrode layer can be made of an inorganic conductive material or an organic conductive material, and includes an active or passive driving circuit. The printing step is performed via an inkjet printing process using a nozzle 50. In FIG. 3B, a solution layer 56 is coated on the first electrode layer 54. The solution layer 56 is a mixture of cholesteric liquid crystal materials capable of reflecting different colors and monomers or macromolecule prepolymers. The cholesteric liquid crystal materials can be cholesteric liquid crystals or a mixture of a twist agent and Nematic liquid crystals. The cholesteric liquid crystal materials can reflect visible light having a wavelength of 400-800 nm. The cholesteric liquid crystal materials can further include a pigment or dye. Moreover, in the manufacturing process, an alignment layer is further coated on a first electrode layer of a lower base. The alignment layer is made of polyvinyl alcohol, polyimide, aramid, nylon, silica or lecithin.

In FIG. 3C, multiple bank structures 58 are formed in the solution layer (also called the cholesteric liquid crystal layer). These bank structures are made of macromolecule materials, which can contain a pigment or dye. The step for forming bank structures is performed via ultraviolet exposure, which induces phase separation. In this step, the present invention uses ultraviolet light 64 and a mask 62 to perform the exposure process. In FIG. 3D, multiple upper covers 60 are formed via ultraviolet exposure, which induces phase separation. In this step, the present invention uses ultraviolet light 64 directly to perform the exposure process. These upper covers 60 are macromolecule protective layers.

In FIG. 3E, a upper base 68 having a second electrode layer 66 is combined with the lower base. The upper base 68 is made of glass or plastic. The second electrode layer is made of inorganic conductive material or organic conductive material, and includes an active or passive driving circuit. The combining process further includes a heating or ultrasonic oscillatory step to mix uniformly the liquid crystal material and the twist agent.

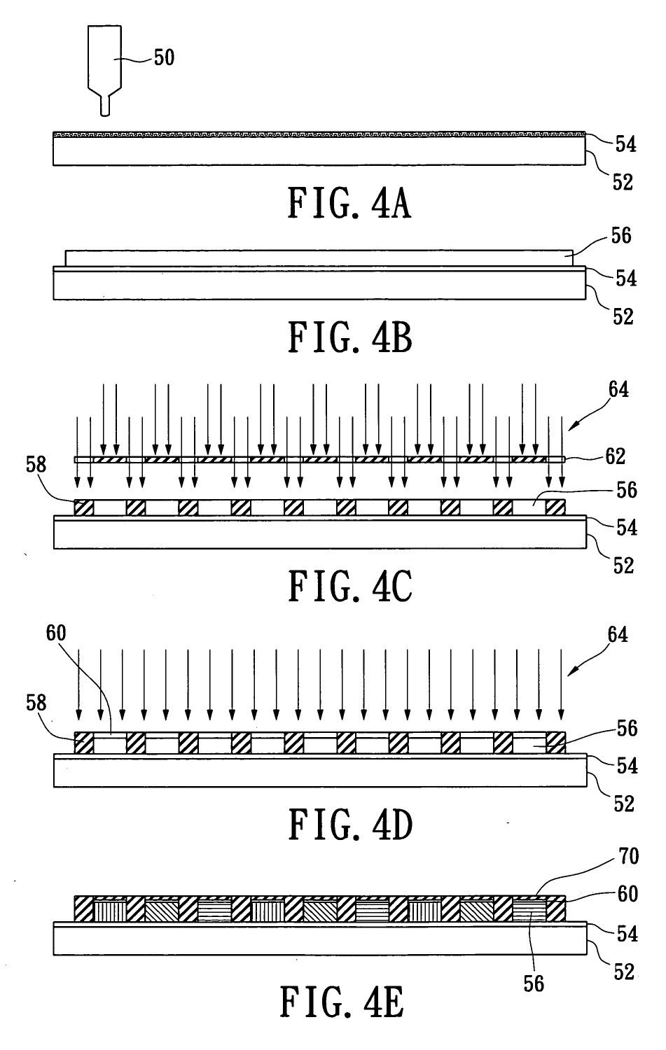

Furthermore, succeeding the step shown in FIG. 3D, in FIG. 4D, the second electrode layer 66 having multiple conductive materials 70 is formed. The second electrode layer 66 is made of inorganic conductive materials and/or organic conductive materials and can also include a black, light absorbent material. The second electrode layer can be made via a screening printing process, an inkjet printing process, a spin-coating process, a blade-coating process and/or a printing process.

In the above embodiment, the twist agent can be mixed with a solvent to change its coating property. The twist agent is then sprinkled onto the lower base having the electrode layer. After a drying process is performed, a liquid crystal material and monomers are coated on the base with the twist agent. Subsequently, the first ultraviolet exposure is provided to form the bank structures, and then the second exposure is performed to form the upper covers (also called upper-cover protective layers). The spectral bands of ultraviolet light provided for the above two exposures can be different.

Then, the lower base is combined with the upper base having a second electrode layer. The combining process is performed by adhering the lower base to the upper base having the second electrode layer. The combining process can be performed by using a direct pressing process, adding an adhesive material, or an ultraviolet exposure process. The second electrode can be formed via an inkjet printing process, a screening printing process or a printing process. Lastly, a tempering process is performed to mix the twist agent and liquid crystal material. The tempering process can be a heating process and/or an ultrasonic oscillatory process.

In the step of forming the second electrode, multiple conductive materials 70 are formed on the upper covers via an inkjet printing process, a screening printing process or a printing process. The conductive materials 70 can also includes a black, light absorbent material. When the printing step is completed, the following combining process can be omitted. The subsequent manufacturing steps are the same as those of the first embodiment. The schematic diagram of the final structure is shown in FIG. 4E. In this embodiment, the present invention has a single-layer structure and thus is thinner. Further, it has a simpler manufacturing process.

In addition, the cholesteric liquid crystal material can have a left-twisted or right-twisted feature. When external light illuminates the cholesteric liquid crystal material, the light matching the twisted feature is reflected while the light not matching the twisted feature passes. Hence, the reflectance is only 50%. Based on this principle, the present invention also proposes a two-layer liquid crystal structure to increase the reflectance. A spacing layer is provided within the two-layer structure to prevent the upper and lower twist agents from being mixed together. The spacing layer is formed via ultraviolet exposure. As shown in FIGS. 4A-4E, the first left-twisted (or right-twisted) cholesteric liquid crystal is made first and then exposed under ultraviolet light to form the spacing layer. After that, the second cholesteric liquid crystal with another twisted feature is arranged thereon.

Furthermore, the arrangement of the pixels of the single-layer cholesteric liquid crystal display device can have various combinative types of twisted features. For example, the three continuous pixels have left-twisted feature and the next three continuous pixels have right-twisted feature. That can also increase the reflectance.

The method for making the conventional cholesteric liquid crystal display device with a single-layer structure and full-color is first to mix the cholesteric liquid crystal material with the twist agent. In this stage, the liquid crystal material has a blue color. Then, via different extents of ultraviolet exposure, the twist agent is partially destroyed to make the liquid crystal material turn green or red. A full-color effect can thus be achieved.

The present invention uses an inkjet printing process and a manufacturing process with two ultraviolet exposures. The inkjet printing process can be used to define the display areas. Using the inkjet printing process can infuse the liquid crystal materials to these display areas to provide the full-color effect. The twist agent can be left-twisted or right-twisted. If a right-twisted agent is added, the light with the wavelength matched to the right-twisted feature is reflected. Moreover, the ingredient proportion of the twist agent affects the spectral band of the reflected light. The advantage of the inkjet printing process is that the positioning is easily controlled so that the materials that need to be infused can be infused into the display areas correctly. Furthermore, the present invention uses the ultraviolet exposure process to form the bank structures to simplify the manufacturing steps and prevent color mixing.

The prior art, such as U.S. Pat. No. 5,949,513, uses a conventional liquid crystal infusing method. The present invention uses an inkjet printing method to sprinkle the cholesteric liquid crystal materials with three colors on the defined display areas and uses two ultraviolet exposure processes to provide a color single-layer cholesteric liquid crystal display device.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

What is claimed is:

1. A method for manufacturing a color cholesteric liquid crystal display device, comprising:
printing a plurality of twist agents onto a first electrode layer of a lower base;
coating the first electrode layer with a solution layer, wherein the solution layer is a mixture of a cholesteric liquid crystal material and monomers;
forming a plurality of bank structures and a plurality of upper covers within the solution layer; and
combining a second electrode layer with the lower base.

2. The method as claimed in claim 1, wherein an upper base and the lower base are made of glass or plastic.

3. The method as claimed in claim 1, wherein the first electrode layer and the second electrode layer include an active driving circuit or a passive driving circuit.

4. The method as claimed in claim 1, wherein the first electrode layer and the second electrode layer are made of an inorganic conductive material or an organic conductive material.

5. The method as claimed in claim 1, wherein the step of printing is performed via an inkjet printing process.

6. The method as claimed in claim 1, wherein the twist agents have different ingredient proportions or are reactive liquid crystal materials.

7. The method as claimed in claim 1, wherein the cholesteric liquid crystal material is a mixture of a twist agent and Nematic liquid crystals.

8. The method as claimed in claim 1, wherein the step of coating is performed via a screening printing process, an inkjet printing process, a spin-coating process, a blade-coating process, a printing process, or a combination thereof.

9. The method as claimed in claim 1, wherein the bank structures are formed via ultraviolet exposure.

10. The method as claimed in claim 9, wherein ultraviolet light and a mask are used for the ultraviolet exposure.

11. The method as claimed in claim 1, wherein the upper covers are formed via ultraviolet exposure.

12. The method as claimed in claim 1, wherein the upper covers are macromolecule protective layers.

13. The method as claimed in claim 1, wherein cholesteric liquid crystals of the solution layer have various combinative types.

14. The method as claimed in claim 1, further comprising a tempering process uniformly mixing the cholesteric liquid crystal material with the twist agents.

15. The method as claimed in claim 14, wherein the tempering process is a heating process or an ultrasonic oscillatory process.

16. The method as claimed in claim 1, wherein the cholesteric liquid crystal material includes multiple cholesteric liquid crystals capable of reflecting different colors.

17. The method as claimed in claim 16, wherein the cholesteric liquid crystal material reflects visible light having a wavelength of about 400-800 nm.

18. The method as claimed in claim 1, wherein the cholesteric liquid crystal material has a pigment or dye.

19. The method as claimed in claim 1, wherein the second electrode layer further includes an upper base.

20. The method as claimed in claim 19, wherein the step of combining the second electrode layer with the lower base is performed by adhering the lower base to the upper base of the second electrode layer.

21. The method as claimed in claim 1, wherein the step of combining the second electrode layer with the lower base includes:
printing multiple conductive materials onto the upper covers to provide the second electrode layer.

22. The method as claimed in claim 21, wherein the conductive materials are black, light absorbent materials.

23. The method as claimed in claim 21, wherein the step of combining is omitted when the step of printing the multiple conductive materials is performed, thus providing a color single-layer cholesteric liquid crystal display device.

24. The method as claimed in claim 1, wherein the step of combining is performed by a direct pressing process or adding an adhesive material.

25. The method as claimed in claim 1, wherein the step of combining is performed by ultraviolet exposure.

26. The method as claimed in claim 1, wherein the lower base is further coated with an alignment layer.

27. The method as claimed in claim 26, wherein the alignment layer is made of polyvinyl alcohol, polyimide, aramid, nylon, silica or lecithin.

28. A color cholesteric liquid crystal display device, comprising: a lower base having a first electrode layer;
a plurality of bank structures distributed over the lower base;
a plurality of cholesteric liquid crystal materials provided between the bank structures;
a plurality of upper covers provided on the cholesteric liquid crystal materials; and
a second electrode layer provided on the upper covers.

29. The device as claimed in claim 28, further comprising an alignment layer coated on the first electrode layer of the lower base.

30. The device as claimed in claim 28, wherein the alignment layer is made of polyvinyl alcohol, polyimide, aramid, nylon, silica or lecithin.

31. The device as claimed in claim 28, further comprising an upper base formed on the second electrode layer.

32. The device as claimed in claim 28, wherein the first electrode layer and the second electrode layer are made of an inorganic conductive material or an organic conductive material.

33. The device as claimed in claim 28, wherein the bank structures are made of a macromolecule material.

34. The device as claimed in claim 32, wherein the macromolecule material has a pigment or dye.

35. The device as claimed in claim 28, wherein the cholesteric liquid crystal materials have a pigment or dye.

36. The device as claimed in claim 28, wherein the second electrode layer is made of a conductive material.

37. The device as claimed in claim 36, wherein the conductive material is a black, light absorbent material.
